(19) United States
(12) Patent Application Publication
(10) Pub. No.: US 2026/0261572 A1
(43) Pub. Date: Sep. 3, 2026

(54) SYSTEM, METHOD, AND COMPUTER PROGRAM PRODUCT FOR IMPROVING VESSEL NAVIGATION SECURITY

(71) Applicant: ELTA SYSTEMS LTD., Ashdod (IL)

(72) Inventor: David TAYOURI, Rishon LeZion (IL)

(21) Appl. No.: 18/875,431

(22) PCT Filed: Jun. 12, 2023
(86) PCT No.: PCT/IL2023/050598

§ 371 Date: Dec. 16, 2024

(30) Foreign Application Priority Data
Jun. 15, 2022 (IL) 294008

(51) Int. Cl. H04L 9/40

(52) U.S. Cl. CPC H04L 63/1425

(57) ABSTRACT

System promoting secure navigation of ships, comprising cyberattack detection apparatus configured to detect cyberattacks against ships' ECDIS systems, including apparatus for comparing data generated by the ECDIS for presentation to the bridge, to input to the ECDIS, and for alerting on occasion/s in which the data generated by the ECDIS is found, based on pre-learning of normal ECDIS data generation behavior not matching the input to the ECDIS, suggesting abnormal ECDIS data generation which may be due to a cyberattack; and/or apparatus for comparing ECDIS maps generated by the ECDIS at times t1, t2 and, accordingly, alerting for possible cyberattack; and/or apparatus configured for analyzing data provided to the ECDIS and, accordingly, alerting for possible cyberattack each time anomaly in data provided to the ECDIS is detected.

### FIELD OF THIS DISCLOSURE

The present invention relates generally to vessels, including those for sea travel, and more particularly to secure navigation of such vessels.

### BACKGROUND FOR THIS DISCLOSURE

The technology described in the following online link: ieeexplore.ieee.org/abstract/document/8899351 describes maritime cyber situational awareness.

The technology described in the following online link: www.sciencedirect.com/science/article/pii/S0925753520303052 describes cyber-risk assessment for ship systems.

The technology described in the following online link: www.ncbi.nlm.nih.gov/pmc/articles/PMC8124306/ uses radar to perform attacks on ECDIS. The publication warns that “integration of radar systems, . . . (AIS) and . . . (ECDIS) . . . make ships prone to cyberattacks”.

The technology described in the following online link: www.mdpi.com/2078-2489/13/3/104/htm describes navigation data anomaly analysis and detection, focusing on NMEA (National Marine Electronics Association electrical and data specification for communication between marine electronics), rather than an ECDIS (Electronic Chart Display and Information System).

The technology described in the following online link: https://thetius.com/brief-guide-to-cybersecurity-in-maritime/ provides general discussion of cybersecurity in maritime.

The technology described in the following online link: www.muninn.ai/muninn-maritime-ai describes a sensor protecting ports and ships. The maritime network sensor agentlessly learns the normal behaviors of each user and device onboard the vessel, but does not provide attack detection.

The technology described in the following online link: rs-class.org/en/news/general/rs-issues-guidelines-on-cyber-safety/ describes cyber safety in general terms, including guidelines.

The technology described in the following online link: www.maritimeglobalsecurity.org/media/1014/c-users-jpl-onedrive-bimco-desktop-guidelines_on_cyber_security_onboard_ships_version_20_july2017.pdf describes cyber safety aboard ships.

The technology described in the following online link: www.researchgate.net/publication/335977458_Safety_related_cyber-attacks_identification_and_assessment_for_autonomous_inland_ships identifies safety related cyber-attacks generally, not specifically vis a vis ECDIS.

The technology described in the following online link: www.researchgate.net/publication/330250566_Detecting_and_Hunting_Cyberthreats_in_a_Maritime_Environment_Specification_and_Experimentation_of_a_Maritime_Cybersecurity_Operations_Centre describes maritime cyber security generally.

The technology described in the following online link: www.blankrome.com/publications/maritime-cybersecurity-prepare-detect-and-respond-0 describes detection of cyber security concerns generally, not specifically vis a vis ECDIS.

The technology described in the following online link:
pearl.plymouth.ac.uk/bitstream/handle/10026.1/19056/Visky%2B079.pdf?sequence=1&isAllowed=y describes a Multi-Purpose Cyber Environment for the maritime sector.

The technology described in the following online link: marine-offshore.bureauveritas.com/ship-owners-guide-achieving-cyber-security provides a general cybersecurity guide.

The technology described in the following online link: backend.orbit.dtu.dk/ws/portalfiles/portal/218483747/190401_Analyzing_the_Attack_Surface_of_Ships.pdf analyzes ships' attack surfaces.

The disclosures of all publications and patent documents mentioned in the specification, and of the publications and patent documents cited therein directly or indirectly, are hereby incorporated by reference, other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Certain embodiments seek to provide a system, method and computer program product which detect cyberattacks against ECDIS, thereby to facilitate secure navigation of a ship. Typically, input data flowing to the EDCIS, e.g., from sensors, is supplied to the system herein, e.g. by intercepting same from the sensors, or by commanding the sensors to provide same to the system herein, or by interfacing with the ECDIS e.g., to an ECDIS database which stores data from the sensors, thereby to obtain the data. Typically, output data generated by the ECDIS is also supplied to the system herein, e.g., by intercepting same from the bridge, or by commanding the bridge to provide same to the system herein, or by interfacing with the ECDIS.

Certain embodiments seek to provide an attack detection process useful in situations in which an ECDIS, or one or more sensors feeding the ECDIS, is/are attacked, and their data is spoofed.

Certain embodiments seek to provide a monitoring system that looks at different data at different layers and detects anomalies that may imply a cyberattack on an ECDIS environment.

It is appreciated that any reference herein to, or recitation of, an operation being performed, e.g., if the operation is performed at least partly in software, is intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g., over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

The present invention typically includes at least the following embodiments:

Embodiment 1: A system promoting secure navigation of ships, the system comprising cyberattack detection apparatus configured to detect cyberattacks against ships' ECDIS systems, the apparatus comprising at least one of: a. apparatus for comparing data generated by the ECDIS for presentation to the bridge, to input to the ECDIS, and for alerting on at least one occasion in which the data generated by the ECDIS is found, based on pre-learning of normal ECDIS data generation behavior not matching the input to the ECDIS, suggesting abnormal ECDIS data generation which may be due to a cyberattack; b. apparatus for comparing an ECDIS map generated by the ECDIS at time t1, to an ECDIS map generated by the ECDIS at time t2 and, accordingly, alerting for a possible cyberattack; andc. apparatus for analyzing data provided to the ECDIS and, accordingly, alerting for a possible cyberattack if an anomaly in the data provided to the ECDIS is detected.

The apparatus may be implemented by one or more hardware processors. Operation 230 in FIG. 3 may use logic configured to compare the two ECDIS maps and, accordingly, to trigger a cyberattack alert, and/or to analyze data provided to the ECDIS and, accordingly, to alert for a possible cyberattack if an anomaly in the data provided to the ECDIS is detected and/or to determine whether data generated does/doesn't match input to the ECIDS. Any suitable criterion of sameness may be used to determine whether data generated does/doesn't match input to the ECDIS. For example, machine learning can be trained to determine whether input does or does not match, based on training data in which anomaly detection, say, is used to determine which inputs to the ECIDS from the past do and do not match data generated by the ECIDS in the past. Or, data generated may be deemed not to match input to the ECIDS if certain computational functions of the data generated differ, using a given suitable metric, from certain computational functions (typically the same computational functions) of the input to the ECIDS; a logical function of such computational functions may be employed to yield a binary match/no match output.

Typically, the system is software-based, and, after having been tested and operationally approved, the system undergoes on-time installation. Software updates, when and if required, may be performed manually, e.g., as software updates on board ships are conventionally updated manually. However, updates need not be remote and, relative to the ECDIS, are also typically much less frequent, yielding an attack surface and risks which are much lower than in the case of the ECDIS.

Typically, it is assumed that during the system's training period, the ECIDS is not compromised, and therefore, during that period, the system herein may safely learn the ECIDS including learning what data is generated by the ECIDS as a function of which input data.

Embodiment 2. A system according to any of the preceding embodiments wherein apparatus a and b are provided, and wherein outputs generated by apparatus a and b are combined to yield an indication of whether or not a cyberattack against the ECDIS has occurred.

Embodiment 3. A system according to any of the preceding embodiments wherein apparatus a and c are provided, and wherein outputs generated by apparatus a and c are combined to yield an indication of whether or not a cyberattack against the ECDIS has occurred.

Embodiment 4. A system according to any of the preceding embodiments wherein apparatus b and c are provided, and wherein outputs generated by apparatus b and c are combined to yield an indication of whether or not a cyberattack against the ECDIS has occurred.

Embodiment 5. A system according to any of the preceding embodiments wherein apparatus a and b and c are provided, and wherein outputs generated by apparatus a and b and c are combined to yield an indication of whether or not a cyberattack against the ECDIS has occurred.

Any suitable logic may be employed to combine the outputs generated by apparatus a and/or b and/or c. An objective of the logic employed to combine these outputs, is to lower false alarms. For example, each time only one of the outputs indicates, e.g., at a low level of certainty or confidence, that a cyberattack has occurred, the system may not generate a cyberattack alert. However, each time two of the outputs concludes, with a high level of certainty or confidence, that an attack has occurred, an alert may be generated, and each time all three outputs conclude an attack has occurred, an alert may be generated, even if the level of certainty or confidence is only medium.

Embodiment 6. A method promoting safe navigation of ships, the method comprising: cyberattack detection configured to detect cyberattacks against ships' ECDIS systems and typically including comparing data received by ECDIS and data which is generated by the ECDIS according to the data received, and/or accordingly, determining whether an anomaly has occurred between how the ECDIS is now generating data, and how the ECDIS generated data in the past, and/or at least once, alerting of a cyberattack responsive to an anomaly detected by the determining.

Embodiment 7. A method according to any of the preceding embodiments which is implemented only in software.

Embodiment 8. A system according to any of the preceding embodiments which is implemented only in software.

Embodiment 9. A method according to any of the preceding embodiments and also comprising using alternative navigation technology and/or manual navigation, until the cyberattack on the ECDIS has been resolved.

Embodiment 10. A method according to any of the preceding embodiments and also performing attack analysis to identify a component which has been compromised.

Embodiment 11. A method according to any of the preceding embodiments and also comprising resolving the cyberattack on the ECDIS by neutralizing the cause of the cyberattack.

Neutralization may be achieved by fixing or updating at least one sensor which has been compromised and/or the ECDIS system itself, if compromised.

Typically, attack analysis is performed to find the attack source and/or the attack vector and/or to determine the compromised component/s which may be the ECDIS system itself and/or one or more of the sensors providing inputs to the ECDIS.

Embodiment 12. A system according to any of the preceding embodiments and also comprising interface/s intercepting input/s which at least one sensor/s provide/s to the ECDIS.

Embodiment 13. A system according to any of the preceding embodiments and also comprising an interface to the ECDIS database which is configured to obtain, from the ECDIS database, inputs which at least one sensor/s has provided to the ECDIS, and which the ECDIS has stored in its database.

Embodiment 14. A method according to any of the preceding embodiments wherein the determining comprises machine-learning a behavioral model describing how the ECDIS generated data in the past and, in real time, determining whether data now being generated by the ECDIS includes at least one anomaly which deviates from the behavioral model.

Embodiment 15. A method according to any of the preceding embodiments wherein the machine-learning comprises obtaining inputs to, and outputs from the ECDIS, during a period of normal operation of the ECDIS, and learning relationships between the inputs and the outputs, to yield the behavioral model.

Embodiment 16. A method according to any of the preceding embodiments wherein the inputs and outputs obtained are time-stamped to enable specific ECDIS outputs to be matched to specific inputs to the ECDIS, responsive to which, the specific outputs were generated by the ECDIS.

All or any subset of the operations of FIGS. 2 and/or 3 may be used in conjunction with a system or method according to any of the embodiments described above or herein.

Embodiment 17. A system according to any of the preceding embodiments wherein the alerting on at least one occasion comprises alerting each time the data generated by the ECDIS is found, based on pre-learning of normal ECDIS data generation behavior, not to match the input to the ECDIS.

Embodiment 18. A computer program product, comprising a non-transitory tangible computer readable medium having computer readable program code embodied therein, the computer readable program code adapted to be executed to implement a method promoting safe navigation of ships, the method comprising:
cyber attack detection configured to detect cyberattacks against ships' ECDIS systems and including:
   comparing data received by ECDIS and data generated by the ECDIS according to the data received,
   accordingly, determining whether an anomaly has occurred between how the ECDIS is now generating data, and how the ECDIS generated data in the past, and,
   at least once, alerting of a cyberattack responsive to an anomaly detected by the determining.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or general-purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display, e.g., on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g., BLE) or wired (e.g., USB)), a computer program stored in memory/computer storage.

The term “process” as used above is intended to include any type of computation or manipulation or transformation of data represented as physical, e.g., electronic, phenomena which may occur or reside, e.g., within registers and/or memories of at least one computer or processor. Use of nouns in singular form is not intended to be limiting; thus, the term processor is intended to include a plurality of processing units which may be distributed or remote, the term server is intended to include plural typically interconnected modules running on plural respective servers, and so forth.

The above devices may communicate via any conventional wired or wireless digital communication means, e.g., via a wired or cellular telephone network, or a computer network such as the Internet.

The apparatus of the present invention may include, according to certain embodiments of the invention, machine readable memory containing or otherwise storing a program of instructions which, when executed by the machine, implements all or any subset of the apparatus, methods, features, and functionalities of the invention shown and described herein. Alternatively, or in addition, the apparatus of the present invention may include, according to certain embodiments of the invention, a program as above which may be written in any conventional programming language, and optionally a machine for executing the program, such as but not limited to a general-purpose computer, which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors, e.g., via a suitable data network. The term “computer” should be broadly construed to cover any kind of electronic device with data processing capabilities, including, by way of non-limiting example, personal computers, servers, embedded cores, computing system, communication devices, processors (e.g., digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g., chips, which may be co-located or remote from one another. Any controller or processor may, for example, comprise at least one CPU, DSP, FPGA, or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols, and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g., a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage, e.g., computer memory, may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s, e.g., as described herein which may, for example, include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus, the term user interface or “UI” as used herein includes also the underlying logic which controls the data presented to the user e.g. by the system display and receives and processes and/or provides to other modules herein, data entered by a user e.g. using her or his workstation/device.

### BRIEF DESCRIPTION OF THE DRAWINGS

FIG. 1 is a block diagram showing an example ECDIS High-Level Architecture operative in accordance with methods herein according to certain embodiments; all or any subset of the illustrated blocks may be provided in practice.

FIG. 2 is a simplified flowchart illustration of an offline portion of a method configured to detect cyberattacks against ECDIS, such as the ECDIS of FIG. 1, according to certain embodiments.

FIG. 3 is a simplified flowchart illustration of an online portion of a method configured to detect cyberattacks against ECDIS, such as the ECDIS of FIG. 1, according to certain embodiments.

FIGS. 4-6 are tables presenting attack surfaces, vulnerabilities and threats; the method of FIGS. 2 and/or 3 may be utilized vis a vis any of these, according to certain embodiments.

FIG. 7 is a simplified block diagram illustrating a high-level architecture of the system; all or any subset of the illustrated blocks may be provided.

FIG. 8 is a simplified block diagram illustration illustrating offline flow, typically based on the architecture of FIG. 7, typically performing the method of FIG. 2, all in accordance with an embodiment of the invention.

FIG. 9 is a simplified block diagram illustration illustrating online flow, typically based on the architecture of FIG. 7, typically performing the method of FIG. 3, all in accordance with an embodiment of the invention.

In block diagrams and flows, arrows between modules or operations may be implemented as APIs and any suitable technology may be used for interconnecting functional components or modules illustrated herein in a suitable sequence or order e.g., via a suitable API/interface. For example, state of the art tools may be employed, such as, but not limited to, Apache Thrift and Avro, which provide remote call support. Or, a standard communication protocol may be employed, such as but not limited to HTTP or MQTT, and may be combined with a standard data format, such as but not limited to JSON or XML. According to one embodiment, one of the modules may share a secure API with another. Communication between modules may comply with any customized protocol or customized query language, or may comply with any conventional query language or protocol.

Methods and systems included in the scope of the present invention may include any subset or all of the functional blocks shown in the specifically illustrated implementations by way of example, in any suitable order, e.g., as shown. Flows may include all or any subset of the illustrated operations, suitably ordered, e.g., as shown. Tables herein may include all or any subset of the fields and/or records and/or cells and/or rows and/or columns described.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs, and may originate from several computer files which typically operate synergistically.

Each functionality or method herein may be implemented in software (e.g., for execution on suitable processing hardware such as a microprocessor or digital signal processor), firmware, hardware (using any conventional hardware technology such as Integrated Circuit Technology) or any combination thereof.

Functionality or operations stipulated as being software-implemented may alternatively be wholly or fully implemented by an equivalent hardware or firmware module, and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer, or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option, such as but not limited to FPGA, ASIC, or DSP, or any suitable combination thereof.

Any hardware component mentioned herein may in fact include either one or more hardware devices, e.g., chips, which may be co-located or remote from one another.

Any method described herein is intended to include within the scope of the embodiments of the present invention also any software or computer program performing all or any subset of the method's operations, including a mobile application, platform or operating system, e.g., as stored in a medium, as well as combining the computer program with a hardware device to perform all or any subset of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

References herein to an Electronic Chart Display and Information System, aka ECDIS, are intended to include a geographic information system or electronic cartographic navigation information system configured for nautical navigation which typically complies with International Maritime Organization (IMO) performance requirements. Typically, an ECDIS displays information from Electronic Navigational Charts (ENC) and may integrate position information, e.g., from position, heading and/or speed, e.g., through water reference systems and/or other navigational sensors. Sensors may interface with an ECDIS such as but not limited to radar and/or Navtex and/or Automatic Identification Systems (AIS), and/or depth sounders. Typically, an ECDIS provides continuous position and navigational safety information, and presents an alarm when a ship approaches navigational hazards. An ECDIS may be programmed to give warning of expected danger, given a ship's position and movement. ECDIS as defined by IHO Publications S-57 and S-52 complies with the conventional paper charts required by Regulation V/19 of the 1974 IMO SOLAS Convention as amended.

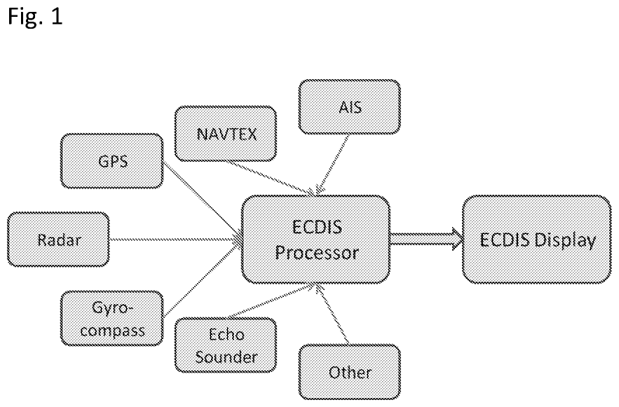

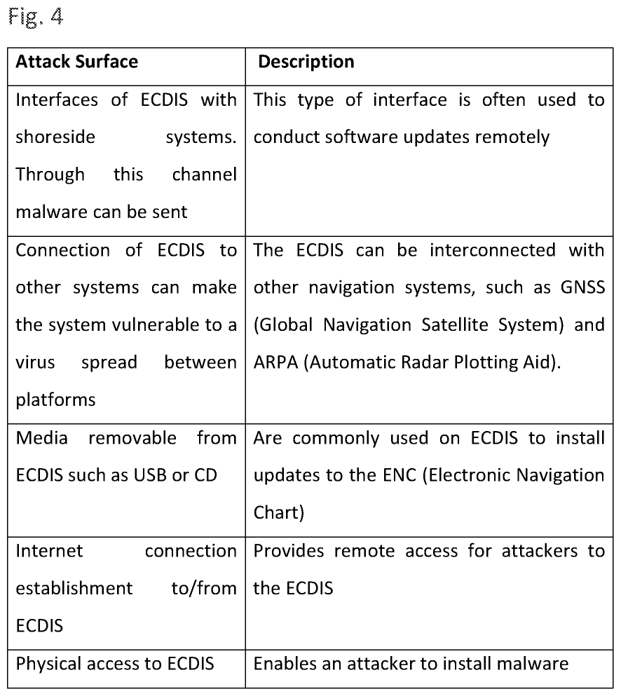

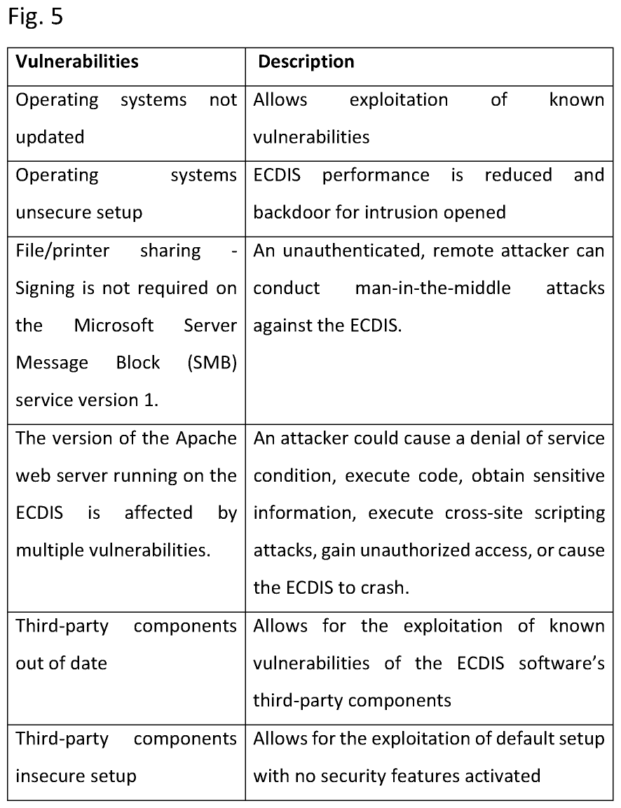

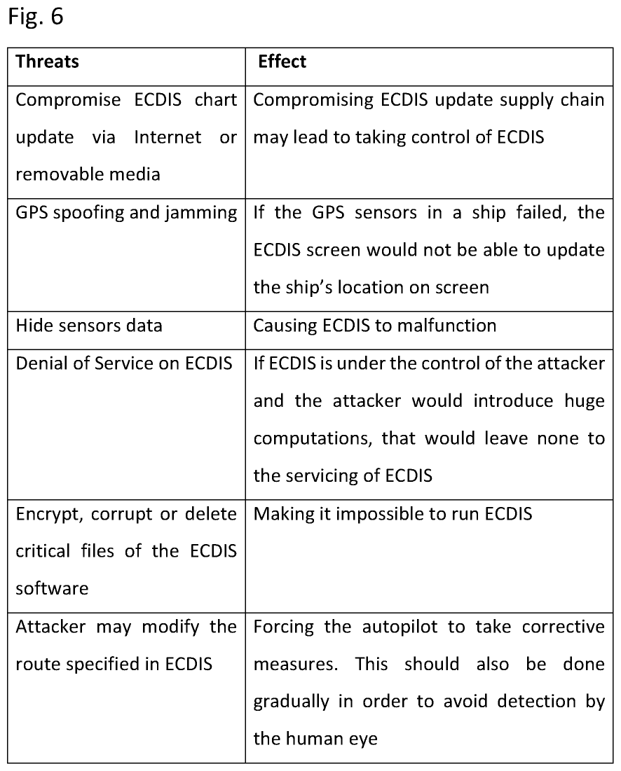

The ECDIS (Electronic Chart Display and Information System) may, e.g., as shown in FIG. 1, collect data from all or any subset of: AIS, GPS, radar, gyroscope, echo sounder, weather station, NAVTEX, gyrocompass or fathometer, or other sensor/s, may merge or combine the data, and may present the data to the bridge, e.g., as an ECDIS display, using an audio or visual output device. The ECDIS may be used for navigation, including automation of certain navigator tasks, thereby increasing navigational safety. However, there are many threats and attack vectors that may disrupt ship navigation by the ECDIS, such as, but not limited to, any of those presented in the tables of FIGS. 4-6.

In contrast, the system and method herein may, itself, be more resilient than the ECDIS, e.g., may not be subject to or not be affected by one, more than one, or many of the ECDIS surfaces/vulnerabilities/threats of FIGS. 4-6, or may be less subject to or less affected by or less frequently subject to or less frequently affected by one, more than one or many of the ECDIS surfaces/vulnerabilities/threats of FIGS. 4-6. For example, the system herein may—unlike the ECDIS—never be updated remotely, and/or the system herein may be updated less frequently than the ECDIS, and therefore, the attack surfaces of the system herein may be less and/or less vulnerable than the attack surfaces of the ECDIS.

Sensors feeding the ECDIS may reside on board the ship (e.g., gyroscope, echo sounder, gyrocompass, fathometer). Some sensors feeding the ECDIS may get their data off-the-air (e.g., AIS, GPS, radar). In any event, it may be assumed that any sensor can be hacked. According to any embodiment herein, the system herein may interface to the sensors and/or to the ECDIS and/or may put a tap typically including software that looks at communication (say between sensors and ECDIS) and extracts certain data therefrom. An example tap includes Wireshark or any suitable alternative, e.g., as described here: www.guru99.com/wireshark-alternative.html.

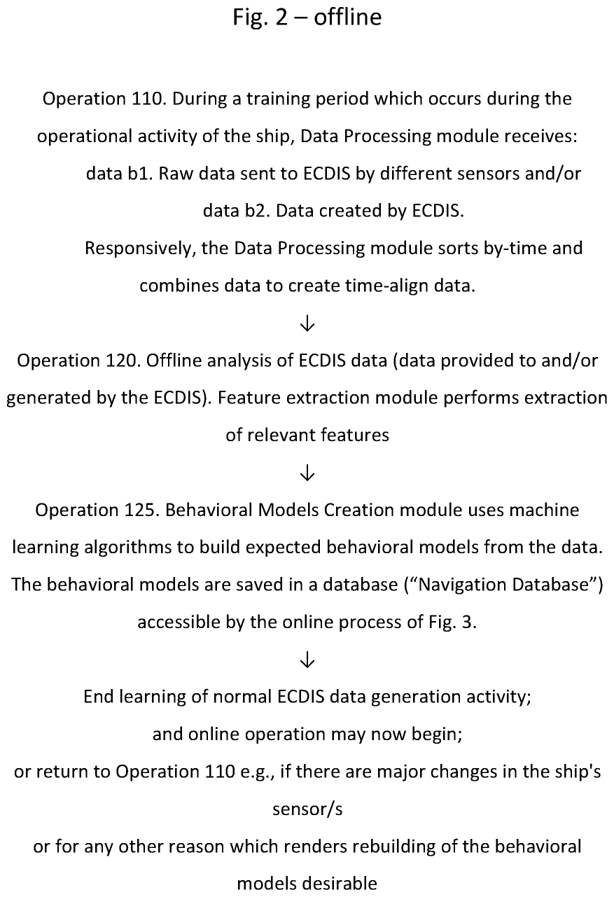

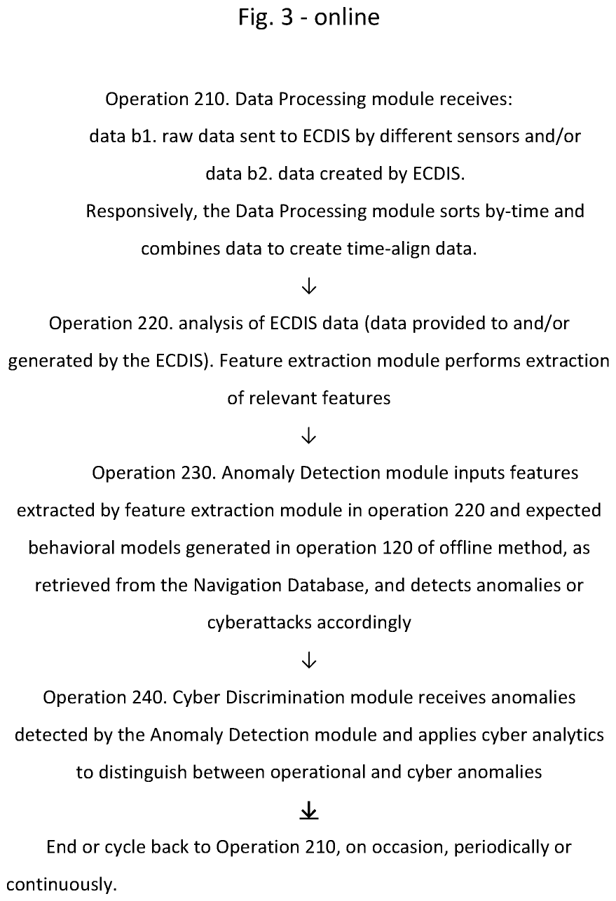

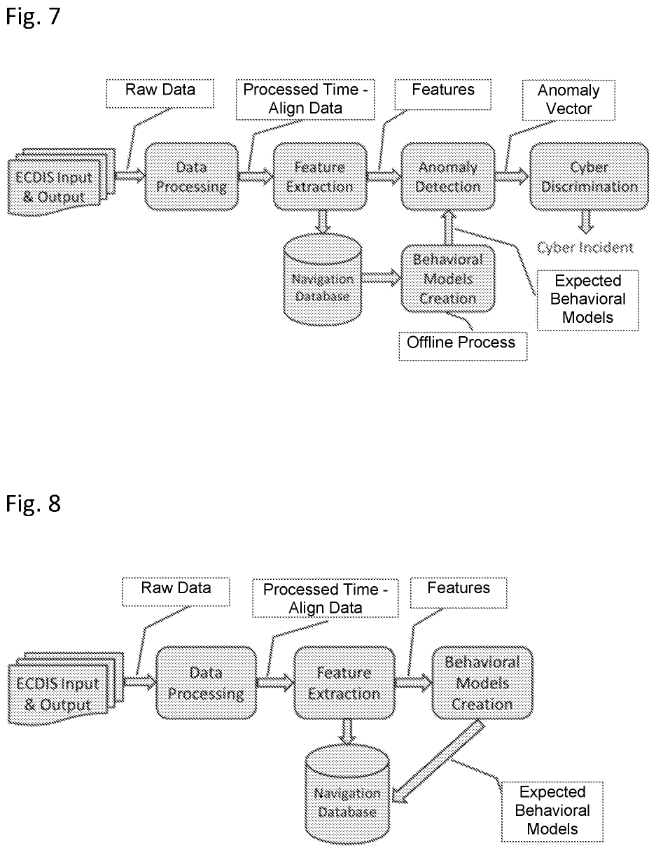

A method for detecting cyber attacks against an ECDIS may include offline operations and online operations as shown in FIGS. 2 and 3 respectively. The method may for example be performed by the system of FIG. 7. In the system of FIG. 7, all or any subset of the illustrated functional blocks may be provided, suitably coupled or with suitable data communication therebetween, e.g., as shown.

The offline operations, e.g. as shown in FIGS. 2 and 8, may include all or any subset of illustrated operations 110, 120, . . . in any suitable order, e.g., as follows:
Operation 110 (may be similar to online operation 210, other than as specified herein). Data Processing module receives:
data b1. raw data sent to ECDIS by different sensors such as but not limited to data arriving from AIS and/or GPS and/or radar and/or gyroscope/s and/or echo sounder and/or weather station and/or NAVTEX and/or gyrocompass and/or fathometer and/or other vessel sensors, and/or
data b2. data created by ECDIS, e.g., visual data (maps with additional information or metadata such as positioning and navigation data), and/or an ECDIS database typically storing processed navigation data.

For example, ECDIS data may include electronic charts for the vessel's intended voyage including Raster Navigational Charts (RNCs) and/or Electronic Navigational Charts (ENCs,) otherwise known as vector charts. Using a vector chart, a user may zoom in on an area to obtain more detail, or may zoom out, e.g., to facilitate looking ahead.

Existing electronic chart service providers include the Admiralty Raster Chart Service (ARCS) and Admiralty Vector Chart Service (AVCS).

A RNC (Raster Navigational Chart) typically comprises a digital image which may be scanned from paper charts into electronic format; geographic references may be added thereto so the chart will refresh in real time. Raster charts may integrate with global positioning system (GPS) coordinates, and may use raster chart display systems (RCDSs.)

An ENC or vector chart includes a graphic representation of objects, e.g., vessels or lighthouses, each of which have attributes. Typically, by selecting, e.g., clicking on an object, its attributes are displayed. Each feature on the vector chart may also have attributes. If a given feature is of interest and other nearby features are not, a user may turn off all features nearby, so as not to clutter her or his view. Also, text may be turned off.

An object's or feature's attributes may vary. Data for vector charts may be collected and organized according to the S-57 data standard. A data authentication and protection standard such as S-63 may be used for vector chart data. The data for these charts may be produced in accordance with suitable specifications such as International Hydrographic Organization (IHO) ENC product specifications.

Responsively, and typically offline, the Data Processing module sorts by-time and combines data (e.g., from plural sensors) to create time-align data. Combining may include correlating and sorting records from different sources according to their respective timestamps, e.g., such that earlier timestamps are ordered before later ones, or vice versa.

The Data Processing module may be employed for both offline and online processing.

Offline analysis of ECDIS data (data provided to and/or generated by the ECDIS) typically includes one or, more typically, both of the following:

Operation 120 (may be similar to online operation 220, other than as specified herein). Feature Extraction module performs extraction of relevant features or parameters, typically from the time-align data generated by the data processing module in operation 110; this typically results in a feature vector which constitutes a reduced representation of the complete initial data (e.g., the input data used by the ECDIS to generate the output data that the ECDIS provides to the bridge). State of the art machine learning may be employed to determine which features are relevant.

Typically, the Feature Extraction module uses machine learning to extract the relevant features (parameters) from the time-align data. In the training phase, any suitable training data may be employed. During the training phase run, the machine learning process is run in the ship for, a duration of, say, a few days of operational activity, during which the system learns the normal behavior of the ECDIS system by treating the inputs and resulting outputs of the ECDIS system during this period of operational activity, as training data, and, accordingly, creating a baseline of ECDIS normal behavior.

Operation 125. Behavioral Models Creation module uses machine learning algorithms to understand the behavior of the ECDIS data and/or to build or create expected behavioral models from the data, typically using the features extracted by the feature extraction module. Each behavioral model typically comprises a baseline representing normal behavior of the data. A behavioral model may be created for individual inputs to the ECDIS (some or all of these) and/or for any combination/s of these.

Typically, the models created in operation 125 represent the ECDIS's behavior in converting input data received by the ECDIS from various sensors, e.g., as shown in FIG. 1, to output data which the ECDIS provides to the bridge.

Typically, the Feature Extraction module uses a machine learning process to extract the relevant features (parameters) from the time-align data. The training data may comprise the same data as the online process 220 of FIG. 3, however, typically, during training, only the offline process works to create the baseline behavior.

Extracted features are typically saved in a database (“Navigation Database”) and/or are sent to an Anomaly Detection module for further processing.

Typically, features are extracted from input data received by the ECDIS from various sensors, e.g., as shown in FIG. 1, and/or from output data which the ECDIS provides to the bridge. Typically, modes generated in operation 125 represent the ECDIS's behavior in converting input data having the features extracted therefrom, to output data having the features extracted from the output data.

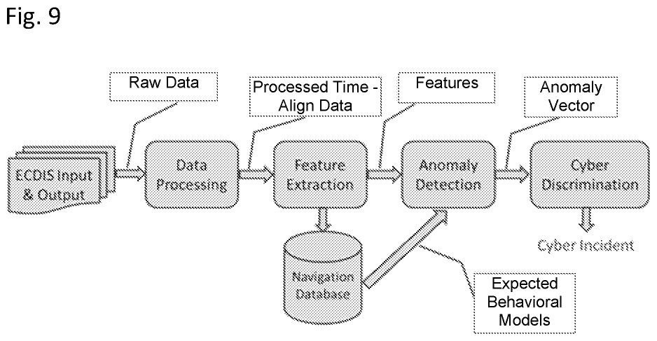

The method for detecting cyberattacks against an ECDIS may also include online or runtime operations. The online or runtime operations, e.g. as shown in FIGS. 3 and 9, may include all or any subset of illustrated operations 210, 220, . . . in any suitable order, e.g., as illustrated. Thus FIG. 3 is a simplified flowchart illustration of operations, all or any subset of which may be performed at runtime.

In Operation 210 the Data Processing module typically receives:
data b1. raw data sent to ECDIS by different sensors and/or
data b2. data created by ECDIS.

Responsively, the Data Processing module sorts by-time and combines data to create time-align data.

In Operation 220 ECDIS data (data provided to and/or generated by the ECDIS) is typically analyzed; a feature extraction module typically performs extraction of relevant features.

In Operation 230, Anomaly Detection module may input features extracted by Feature Extraction module in operation 220 and expected behavioral models generated in operation 120 of the offline method, as retrieved from the Navigation Database, and may detect anomalies or cyberattacks accordingly.

In Operation 240. Cyber Discrimination module receives anomalies detected by the Anomaly Detection module and applies cyber analytics to distinguish between operational and cyber anomalies.

The method then may either end or cycle back to Operation 210, on occasion, periodically or continuously.

In Operation 130, the Anomaly Detection module may input features extracted by feature extraction module in operation 120a and expected behavioral models generated in operation 120b, and may detect cyberattacks accordingly. Any suitable cyberattack detection method may be employed, such as but not limited to any of the following, in isolation, or in any suitable combination:

Using machine learning, aka ML, to learn the normal behavior of ECDIS input data, and detect inconsistent behavior (anomalies). After a training process, a baseline behavior model may be generated. Then, during the online process (e.g., operation 230 of FIG. 3), inputs to the ECDIS may be compared to the baseline, and any difference above a defined threshold may be considered an anomaly.

Using ML to learn or estimate the correlation between ECDIS input and output data and searching for inconsistencies. After the training process, a baseline behavior model may be generated. Then, during the online process (operation 230 of FIG. 3), inputs are compared to the baseline, and any difference above a defined threshold may be considered an anomaly.

Comparing a ECDIS generated map to a previously generated map and computing differences therebetween, typically at the pixel level, e.g., differences, are computed between the values of pixel in both maps. These differences should not pass certain limits. The limits, aka thresholds, may be defined on individual pixels and/or on regions of pixels. Any suitable image processing algorithms from the vision domain may be employed to compare the maps and highlight differences therebetween. If the differences do pass the limits, this may be considered an indication of incorrect data, which may have been malevolently changed by an attack.

By way of non-limiting example, the structural similarity Index, developed by Wang et al, aka the SSIM method, and/or a least-squares based method, may be used to compare maps, e.g., if aligned. Keypoint detectors and local invariant descriptors, e.g., SIFT, SURF, ORB, are available.

The image analysis and/or anomaly detection may use ML. for example, deep learning-based methods for determining image similarity include Siamese networks.

Typically, Operation 240 is configured to distinguish those anomalies detected in operation 130 which indicate true alarms, from those which indicate false alarms. Behavioral anomalies may be operational (hence may be considered false alarms), or may be caused by cyber intervention (hence may be considered true alarms). A Cyber Discrimination module may receive anomalies detected by the Anomaly Detection module and apply cyber analytics to distinguish between operational and cyber anomalies, using any suitable techniques, such as but not limited to:
240a. Identifying malicious anomaly sequences, e.g., comparing the anomaly to sequences which are known as malicious; and/or
240b. Temporal analysis of anomaly sequences, e.g., tracking the anomaly over a defined period of time; if the anomaly disappears during this period, it may not be deemed a cyberattack, whereas if the anomaly persists over the entire period, it may be deemed a cyberattack; and/or
240c. Peer groups analysis, e.g., cross referencing suspicious data (e.g., as determined using techniques 140a and 140b) with similar data, e.g., data with the same timestamp and/or the same geographical area from other sources; if the suspicious data differs from, or is an outlier relative to all of the other sources, the suspicious data may be deemed a cyberattack.

Any suitable criteria may be employed to define/select and group peers.

The method of FIGS. 2, 3 may be employed for all attack surfaces described herein and/or for all vulnerabilities described herein and/or for all threats described herein. According to certain embodiments, the flow may be customized to a given attack surface and/or vulnerability and/or threat e.g., by providing training data that is specific to a given attack surface and/or vulnerability and/or threat. The flow may, if desired, then be repeated plural times, once customized for certain attack surfaces, and once for others (or once customized for a certain vulnerability, and again when customized for a given threat).

According to certain embodiments, data generated by the methods shown and described herein, e.g., data representing at least one behavior model of the ECDIS, is saved in a database (“Navigation Database”) which is external to the ECDIS database.

It may occur that malware is deployed between sensors and ECDIS, e.g., as a man-in-the-middle technique. Therefore, according to certain embodiments, input data is obtained both from the sensors and from the ECDIS database, and the two are compared; an alert may be generated each time an over-threshold discrepancy is detected.

A particular advantage of methods and systems shown and described herein is that these may enable detection of cyberattacks against legacy ECDIS systems which were not originally constructed to facilitate detection of cyberattacks against them.

It is appreciated that terminology such as “mandatory”, “required”, “need” and “must” refer to implementation choices made within the context of a particular implementation or application described herewithin for clarity, and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device, or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations, as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently, rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform, e.g., in software any operations shown and described herein; information storage devices or physical records, such as disks or hard drives, causing at least one computer or other device to be configured so as to carry out any or all of the operations of any of the methods shown and described herein, in any suitable order; at least one program pre-stored, e.g., in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer-or machine-readable media.

Any computations or other forms of analysis described herein may be performed by a suitable computerized method. Any operation or functionality described herein may be wholly or partially computer-implemented, e.g., by one or more processors. The invention shown and described herein may include (a) using a computerized method to identify a solution to any of the problems or for any of the objectives described herein, the solution optionally including at least one of a decision, an action, a product, a service or any other information described herein, that impacts, in a positive manner, a problem or objectives described herein; and (b) outputting the solution.

The system may, if desired, be implemented as a network, e.g., web-based system employing software, computers, routers and telecommunications equipment, as appropriate.

Any suitable deployment may be employed to provide functionalities, e.g., software functionalities shown and described herein. For example, a server may store certain applications, for download to clients, which are executed at the client side, the server side serving only as a storehouse. Any or all functionalities, e.g., software functionalities shown and described herein, may be deployed in a cloud environment. Clients, e.g., mobile communication devices, such as smartphones, may be operatively associated with, but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true, and sometimes false, is currently true or false, and to perform y each time x is determined to be true, thereby to yield a processor which performs y at least once, typically on an “if and only if” basis, e.g., triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous, given the state or condition or data, and/or may prevent at least one outcome which is disadvantageous, given the state or condition or data. Alternatively, or in addition, an alert may be provided to an appropriate human operator or to an appropriate external system.

Features of the present invention, including operations, which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server, or client, or node. Features may also be combined with features known in the art, and particularly, although not limited to, those described in the Background section, or in publications mentioned therein.

Conversely, features of the invention, including operations, which are described for brevity in the context of a single embodiment, or in a certain order, may be provided separately or in any suitable sub-combination, including with features known in the art (particularly although not limited to those described in the Background section, or in publications mentioned therein), or in a different order. “e.g.” is used herein in the sense of a specific example which is not intended to be limiting. Each method may comprise all or any subset of the operations illustrated or described, suitably ordered, e.g., as illustrated or described herein.

Devices, apparatus or systems shown coupled in any of the drawings may, in fact, be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g., iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation, and is not intended to be limiting.

Any suitable communication may be employed between separate units herein, e.g., wired data communication and/or in short-range radio communication with sensors such as cameras e.g., via Wifi, Bluetooth, or Zigbee.

It is appreciated that implementation via a cellular app as described herein is but an example, and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile, e.g., laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node).

Any operation or characteristic described herein may be performed by another actor outside the scope of the patent application, and the description is intended to include apparatus, whether hardware, firmware, or software which is configured to perform, enable, or facilitate that operation, or to enable, facilitate, or provide that characteristic.

The terms processor or controller or module or logic as used herein are intended to include hardware such as computer microprocessors, or hardware processors, which typically have digital memory and processing capacity, such as those available from, say Intel and Advanced Micro Devices (AMD). Any operation or functionality or computation or logic described herein may be implemented entirely or in any part on any suitable circuitry including any such computer microprocessor/s as well as in firmware or in hardware, or any combination thereof.

It is appreciated that elements illustrated in more than one drawing, and/or elements in the written description may still be combined into a single embodiment, except if otherwise specifically clarified herewithin. Any of the systems shown and described herein may be used to implement or may be combined with, any of the operations or methods shown and described herein.

It is appreciated that any features, properties, logic, modules, blocks, operations or functionalities described herein, which are, for clarity, described in the context of separate embodiments, may also be provided in combination in a single embodiment, except where the specification or general knowledge specifically indicates that certain teachings are mutually contradictory, and cannot be combined. Any of the systems shown and described herein may be used to implement, or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art. Each element e.g., operation described herein may have all characteristics and attributes described or illustrated herein, or, according to other embodiments, may have any subset of the characteristics or attributes described herein.

1-21. (canceled)

22. A system promoting secure navigation of ships, the system comprising:
cyberattack detection apparatus configured to detect cyberattacks against ships' ECDIS systems, the apparatus comprising at least one of:
a. apparatus for comparing data generated by the ECDIS for presentation to the bridge, to input to the ECDIS, and for alerting for a possible cyberattack on at least one occasion in which the data generated by the ECDIS is found, based on pre-learning of normal ECDIS data generation behavior not matching the input to the ECDIS, suggesting abnormal ECDIS data generation which may be due to a cyberattack;
b. apparatus for comparing an ECDIS map generated by the ECDIS at time t1, to an ECDIS map generated by the ECDIS at time t2 and, accordingly, alerting for a possible cyberattack; and
c. apparatus for analyzing data provided to the ECDIS and, accordingly, alerting for a possible cyberattack if an anomaly in the data provided to the ECDIS is detected.

23. A system according to claim 22, wherein apparatus a and b are provided, and wherein outputs generated by apparatus a and b are combined to yield an indication of whether or not a cyberattack against the ECDIS has occurred.

24. A system according to claim 22, wherein apparatus a and c are provided, and wherein outputs generated by apparatus a and c are combined to yield an indication of whether or not a cyberattack against the ECDIS has occurred.

25. A system according to claim 22, wherein apparatus b and c are provided, and wherein outputs generated by apparatus b and c are combined to yield an indication of whether or not a cyberattack against the ECDIS has occurred.

26. A system according to claim 22, wherein apparatus a and b and c are provided, and wherein outputs generated by apparatus a and b and c are combined to yield an indication of whether or not a cyberattack against the ECDIS has occurred.

27. A system according to claim 22, which is implemented only in software.

28. A system according to claim 22, and also comprising interface/s intercepting input/s which at least one sensor/s provide/s to the ECDIS.

29. A system according to claim 22, and also comprising an interface to the ECDIS database which is configured to obtain, from the ECDIS database, inputs which at least one sensor/s has provided to the ECDIS, and which the ECDIS has stored in its database.

30. A system according to claim 22, wherein said alerting on at least one occasion comprises alerting each time the data generated by the ECDIS is found, based on pre-learning of normal ECDIS data generation behavior, not to match the input to the ECDIS.

31. A system according to claim 22, wherein apparatus a is provided.

32. A system according to claim 22, wherein apparatus b is provided.

33. A system according to claim 22, wherein apparatus c is provided.

34. A method promoting safe navigation of ships, the method comprising:
cyberattack detection configured to detect cyberattacks against ships' ECDIS systems and including:
comparing data received by ECDIS and data generated by the ECDIS according to said data received,
accordingly, determining whether an anomaly has occurred between how the ECDIS is now generating data, and how the ECDIS generated data in the past, and, at least once, alerting of a cyberattack responsive to an anomaly detected by said determining.

35. A method according to claim 34, which is implemented only in software.

36. A method according to claim 34, and also comprising using alternative navigation technology and/or manual navigation, until the cyberattack on the ECDIS has been resolved.

37. A method according to claim 34, and also performing attack analysis to identify a component which has been compromised.

38. A method according to claim 34, and also comprising resolving the cyberattack on the ECDIS by neutralizing the cause of the cyberattack.

39. A method according to claim 34, wherein said determining comprises machine-learning a behavioral model describing how the ECDIS generated data in the past and, in real time, determining whether data now being generated by the ECDIS includes at least one anomaly which deviates from the behavioral model.

40. A method according to claim 39, wherein said machine-learning comprises obtaining inputs to, and outputs from the ECDIS, during a period of normal operation of the ECDIS, and learning relationships between said inputs and said outputs, to yield the behavioral model.

41. A method according to claim 40, wherein the inputs and outputs obtained are time-stamped to enable specific ECDIS outputs to be matched to specific inputs to the ECDIS, responsive to which, the specific outputs were generated by the ECDIS.

42. A computer program product, comprising a non-transitory tangible computer readable medium having computer readable program code embodied therein, said computer readable program code adapted to be executed to implement a method promoting safe navigation of ships, the method comprising:
cyber attack detection configured to detect cyberattacks against ships' ECDIS systems and including:
comparing data received by ECDIS and data generated by the ECDIS according to said data received,
accordingly, determining whether an anomaly has occurred between how the ECDIS is now generating data, and how the ECDIS generated data in the past, and, at least once, alerting of a cyberattack responsive to an anomaly detected by said determining.
